(19) United States
(12) Patent Application Publication
(10) Pub. No.: US 2016/0288374 A1
(43) Pub. Date: Oct. 6, 2016

(54) CLEANING METHOD FOR LIQUID DISCHARGE APPARATUS, LIQUID DISCHARGE APPARATUS, IMPRINT APPARATUS, AND METHOD OF MANUFACTURING ARTICLE

(71) Applicant: CANON KABUSHIKI KAISHA, Tokyo (JP)

(72) Inventors: Bharath Thiruvengadachari, Round Rock, TX (US); Christopher J. Fleckenstein, Round Rock, TX (US); Van Nguyen Truskett, Austin, TX (US); Charles Scott Carden, Austin, TX (US); Tsuyoshi Arai, Utsunomiya-shi (JP); Kensuke Tone, Utsunomiya-shi (JP)

(21) Appl. No.: 14/673,074

(22) Filed: Mar. 30, 2015

(51) Int. Cl. B29C 33/72; B29C 59/02; B08B 3/08

(52) U.S. Cl. CPC B29C 33/72; B08B 3/08; B29C 59/022

(57) ABSTRACT

A head cleaning method performed by a liquid discharge apparatus including a head configured to discharge a resist containing an acrylic monomer as a main component is provided. The method comprises using a cleaning solution to clean a discharge surface of the head and a vicinity of the discharge surface, wherein a difference between a dissolution parameter (SP value) of the cleaning solution and a dissolution parameter of the resist falls within a range of ±2.

### BACKGROUND OF THE INVENTION

1. Field of the Invention

The present invention relates to an imprint technique and, more particularly, to cleaning around a liquid discharge surface of a liquid discharge apparatus.

2. Description of the Related Art

In the manufacturing process of a semiconductor device or the like, an imprint apparatus using a nanoimprint technique is in practical use as a lithography apparatus substituted for an exposure apparatus. In the imprint apparatus, a liquid discharge apparatus is arranged to apply a liquid (resin or resist) from discharge nozzles onto a substrate. As a method of applying a resist, an inkjet method of performing drawing by discharging droplets from a discharge head has been devised. In recent years, a liquid discharge apparatus adopting the inkjet method is used in various fields. In the liquid discharge apparatus, droplets may be attached near an opening (orifice) formed in the liquid discharge surface of the discharge head. If the droplets are left to stand, the liquid is dried and adhered, and thus cannot be removed. Japanese Patent Laid-Open No. 2003-182088 and Japanese Patent Laid-Open No. 2008-068560 each disclose a unit for cleaning ink droplets attached near an orifice.

As described above, an imprint apparatus uses an inkjet technique in a step of applying a resist (resin) onto a substrate. If the resist is adhered near an orifice of the discharge head, discharge characteristics such as the amount, discharge direction, or discharge speed of a liquid discharged from the orifice are disturbed.

### SUMMARY OF THE INVENTION

To recover the discharge performance, it is effective to clean the orifice of the discharge head. According to one aspect of the present invention, a head cleaning method performed by a liquid discharge apparatus including a head configured to discharge a resist containing an acrylic monomer as a main component is provided. The method comprises using a cleaning solution to clean a discharge surface of the head and a vicinity of the discharge surface, wherein a difference between a dissolution parameter (SP value) of the cleaning solution and a dissolution parameter of the resist falls within a range of ±2.

Further features of the present invention will become apparent from the following description of exemplary embodiments with reference to the attached drawings.

### BRIEF DESCRIPTION OF THE DRAWINGS

FIG. 1 is a view showing the apparatus arrangement of an imprint apparatus in a normal state according to the present invention;

FIG. 2 is a view showing the apparatus arrangement of the imprint apparatus at the time of maintenance according to the present invention;

FIG. 3 is a block diagram showing a maintenance procedure of a liquid discharge apparatus according to the present invention;

FIG. 4 is a view showing a method of cleaning liquid orifices according to the present invention;

FIGS. 5A-5F are views showing a cleaning method using the liquid discharge apparatus according to the present invention;

FIG. 6 is a view showing a cleaning method using the liquid discharge apparatus according to the present invention;

FIGS. 7A-7B are views showing a cleaning method using the liquid discharge apparatus according to the present invention;

FIGS. 8A-8B are views showing a method of removing the residual liquid of the liquid orifices according to the present invention;

FIG. 9 is a view showing a method of removing the residual liquid of the liquid orifices according to the present invention; and

FIG. 10 is a view showing a method of removing the residual liquid of the liquid orifices according to the present invention.

### DESCRIPTION OF THE EMBODIMENTS

Various exemplary embodiments, features, and aspects of the invention will be described in detail below with reference to the drawings.

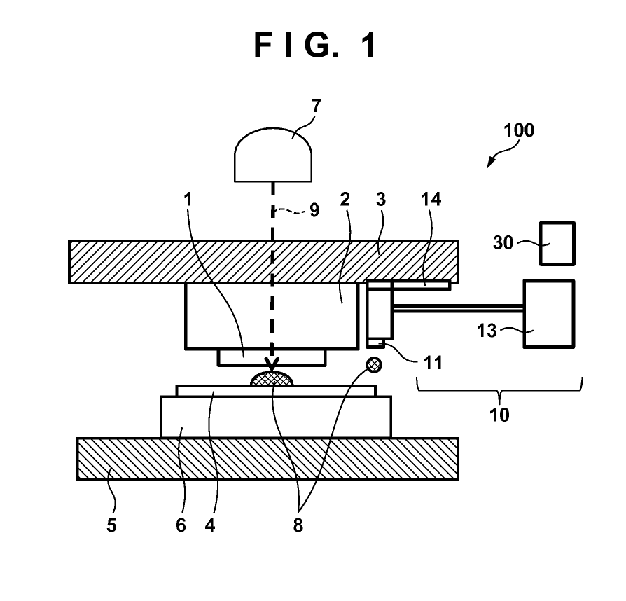

A liquid discharge apparatus and an imprint apparatus using the liquid discharge apparatus according to an embodiment of the present invention will be schematically described with reference to FIG. 1. Note that the applicable range of the liquid discharge apparatus according to the present invention is not limited to the imprint apparatus, and the liquid discharge apparatus is widely applicable to apparatuses with a liquid discharge mechanism, for example, industrial apparatuses such as a semiconductor manufacturing apparatus and liquid crystal manufacturing apparatus, and consumer products such as a printer.

A case in which the present invention is applied to a UV light-curing imprint apparatus which cures a resin (resist) by irradiation with UV light (ultraviolet light) will be exemplified. The present invention is also applicable to an imprint apparatus which cures a resin by irradiation with light having another wavelength region, and an imprint apparatus which cures a resin using another energy (for example, heat), as a matter of course.

An imprint apparatus 100 is an apparatus for transferring a pattern by applying a resist 8 onto a substrate 4 using a liquid discharge apparatus 10, bringing a mold 1 into contact with the applied resist 8, and irradiating, in this state, the resist 8 with ultraviolet light 9 from an ultraviolet light generator 7 to cure the resist. The mold 1 has a fine three-dimensional pattern formed on it, and can form, on the substrate 4, an element pattern corresponding to the mold pattern.

A substrate stage 6 can move on a base frame 5 while holding the substrate 4. A mold driving mechanism 2 which drives the mold 1 upward and downward is held by a structure 3, and can perform an operation of moving the mold 1 close to the substrate 4 and pressing the mold 1 against a resist 8 on the substrate 4. The ultraviolet light generator 7 is arranged above the mold 1, and irradiates the resist 8 with the ultraviolet light 9 through the mold 1 to cure the resist 8. The ultraviolet light generator 7 includes a light source such as a halogen lamp which generates an i-line or g-line, and has a function of condensing and shaping the light emitted from the light source to generate the ultraviolet light 9.

An imprint operation according to this embodiment will be described. First, the substrate 4 is mounted on the stage 6. The stage 6 moves the substrate 4 to a position below a discharge head 11 of the liquid discharge apparatus 10. When the discharge head 11 discharges a predetermined amount of the resist 8 while moving the stage 6, the resist 8 is applied to the substrate 4 at predetermined positions. By moving the substrate stage 6, a portion of the substrate 4 where the resist 8 is applied is moved to a position below the mold 1. Furthermore, the mold driving mechanism 2 moves the mold 1 in the downward direction so that the mold 1 and the substrate 4 are close to each other. In this state, an alignment scope (not shown) adjusts the relative positions of the mold 1 and the substrate 4 by overlaying the alignment mark of the mold 1 on the alignment mark of the substrate 4.

The mold driving mechanism 2 further moves the mold 1 in the downward direction toward the substrate 4 to press the pattern of the mold 1 against the resist 8. After that, the ultraviolet light generator 7 emits the ultraviolet light 9, and irradiates the resist 8 with the ultraviolet light 9 having passed through the mold 1. The light curing reaction of the resist 8 starts, and the resist 8 is cured. Finally, the mold driving mechanism separates the mold 1 from the cured resist. This forms the pattern on the substrate 4, thereby terminating the imprint operation.

The liquid discharge apparatus 10 according to the present invention will now be described. The resist 8 is discharged from the discharge head 11 when a controller 30 controls the discharge head 11. The discharge head 11 preferably uses the inkjet technique. A pressure control unit 13 is formed from a filling liquid tank, pipe, pressure sensor, pump, valve, and the like. The pressure sensor, pump, and valve are connected to the control unit to control the pressure of the liquid to be discharged. The pressure control unit 13 stabilizes the shape of the discharge interface (meniscus) of the discharge head 11, thereby achieving satisfactory discharge with high reproducibility.

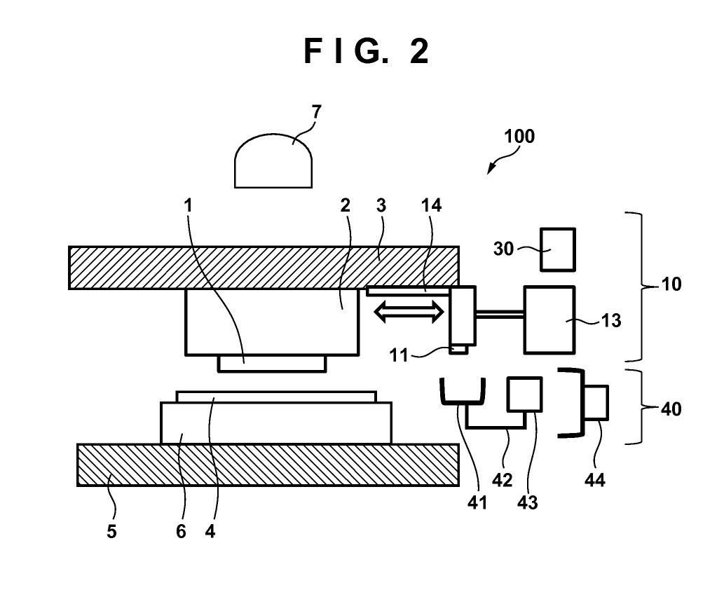

As shown in FIG. 2, the imprint apparatus according to the present invention includes a moving mechanism 14 for moving two positions, that is, a normal discharge position and a position moved outside the imprint apparatus. The position moved outside the apparatus will be referred to as a maintenance position. The imprint apparatus is configured to improve access to a discharge nozzle portion and facilitate maintenance.

Based on an imprint sequence, the discharge head 11 repeatedly discharges the resist 8. While repeating discharge for a long period of time, the discharge performance may change due to the adhesion of the resist around the discharge head 11. The imprint apparatus 100 and the liquid discharge apparatus 10 periodically confirm the discharge state of the resist discharged from the discharge head 11. The change of the performance such as the landing position shift of the discharged resist is confirmed by, for example, observing, using a microscope (not shown), droplets discharged, exposed, and cured on the substrate 4 for maintenance on the substrate stage 6.

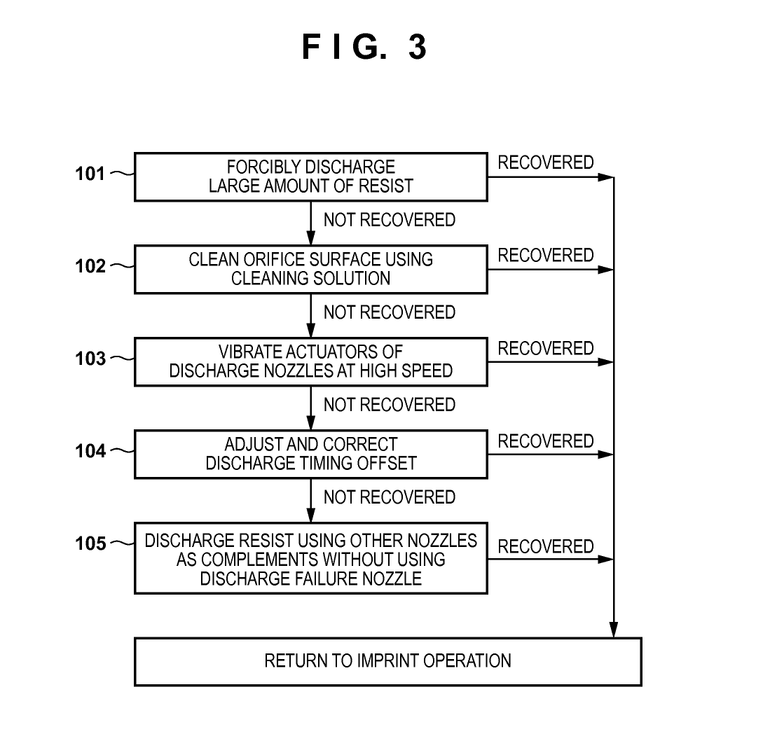

The performance is confirmed in this way. If an abnormality is determined, for example, if no resist is discharged from a specific discharge nozzle of the discharge head or the landing position of the discharged resist shifts, a recovery operation (maintenance or cleaning) is performed according to steps shown in FIG. 3.

A large amount of the resist is forcibly discharged (a resist in a supply apparatus may be replaced by a new one) (101). If the abnormality is not recovered yet, cleaning is performed using a cleaning solution (102). If the abnormality is not recovered yet, the actuators of the discharge nozzles are vibrated at high speed (within the ultrasonic wave band) (103). If the abnormality is not recovered yet, a discharge timing offset is adjusted and corrected (104). If the offset cannot be sufficiently corrected, other nozzles serve as complements to discharge the resist without using the discharge failure nozzle (105).

Each item will be described in detail below.

101. A large amount of the resist is forcibly discharged.

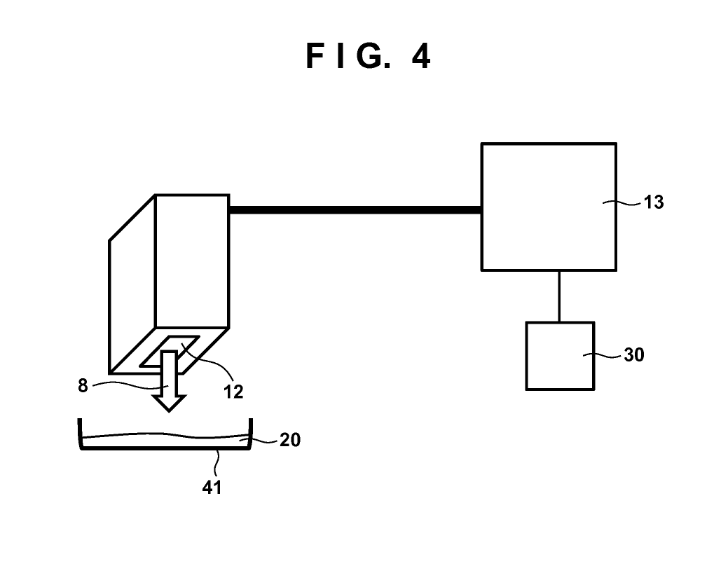

The volatile components of the resist existing in the vicinity of the discharge nozzles may evaporate to change the viscosity of the resist, thereby changing the discharge performance. To solve this problem, an operation of forcibly discharging a large amount of the resist is performed for the purpose of removing the old resist in the discharge nozzles. In this case, the substrate 4 for maintenance may be mounted on the substrate stage 6, and the resist may be discharged onto the substrate 4. The imprint apparatus 100 of the present invention includes a drain tray 41 at the maintenance position, as shown in FIGS. 2 and 4, and can discharge the resist to the drain tray 41 after driving the moving mechanism 14 to move the discharge nozzle 11 to the maintenance position.

If it is probable that the resist changes with time to change its properties, all the resist in the pressure control unit 13 may be discharged, and a new resist may be supplied to the pressure control unit 13 to discharge the new resist from the discharge head 11.

A discharge abnormality caused by the change of the properties of the resist is recovered by performing this step.

102. Cleaning is performed using a cleaning solution.

Even if a large amount of the resist is discharged, if non-discharge or a landing position shift is not recovered, the resist may be adhered near the discharge nozzles. Adhesion indicates a state in which the volatile components of the resist evaporate and the residue remains around the discharge nozzles. To solve this problem, a step of dissolving and removing the adhered resist is performed.

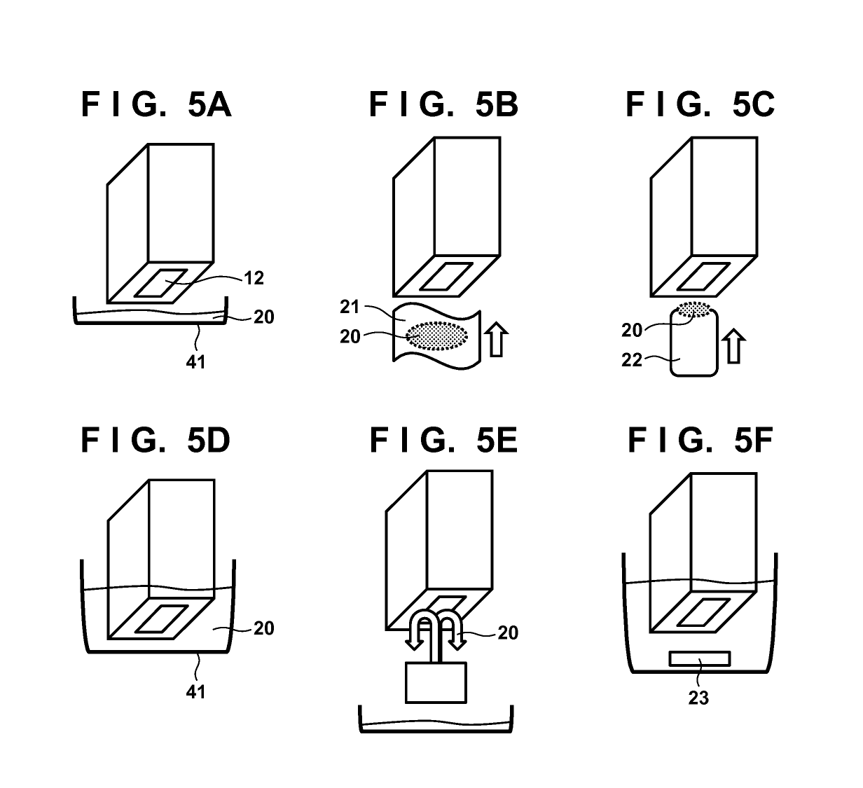

To dissolve the adhered resist, a cleaning solution is used in this step. FIGS. 5A-5F show a method of cleaning the discharge nozzles by a cleaning solution 20. FIG. 5A shows a state in which the drain tray 41 accommodates the cleaning solution 20 to wet the adhered resist with steam of the cleaning solution 20. If the tray accommodating the cleaning solution is arranged near a resist discharge surface 12 of the discharge head, and left to stand for a given time, it becomes easy to clean the resist in a subsequent step.

FIG. 5B shows a state in which the vicinity of the discharge surface 12 is wiped with nonwoven fabric 21 impregnated with the cleaning solution 20. To prevent the discharge surface 12 including the discharge nozzles from being damaged, the nonwoven fabric 21 may only be pressed against the discharge surface 12 without rubbing. As shown in FIG. 5C, another method may be used to wipe the vicinity of the discharge surface 12 with a sponge 22 impregnated with the cleaning solution 20. In either case, it is necessary to wipe the vicinity of the discharge surface 12 with something which is kept clean and free from dust.

FIG. 5D shows a state in which the cleaning solution 20 is put into the drain tray 41, and the discharge surface 12 is soaked to dissolve solids. As shown in FIG. 5E, the discharge surface 12 may be cleaned by a jet of the cleaning solution 20. The orifices may be cleaned by a so-called two-fluid cleaning method of emitting a jet of the cleaning solution using a carrier gas such as clean nitrogen. As shown in FIG. 5F, an ultrasonic vibrator 23 may be arranged in the drain tray 41 together with the cleaning solution 20, thereby performing cleaning using a physical force by vibration or cavitation.

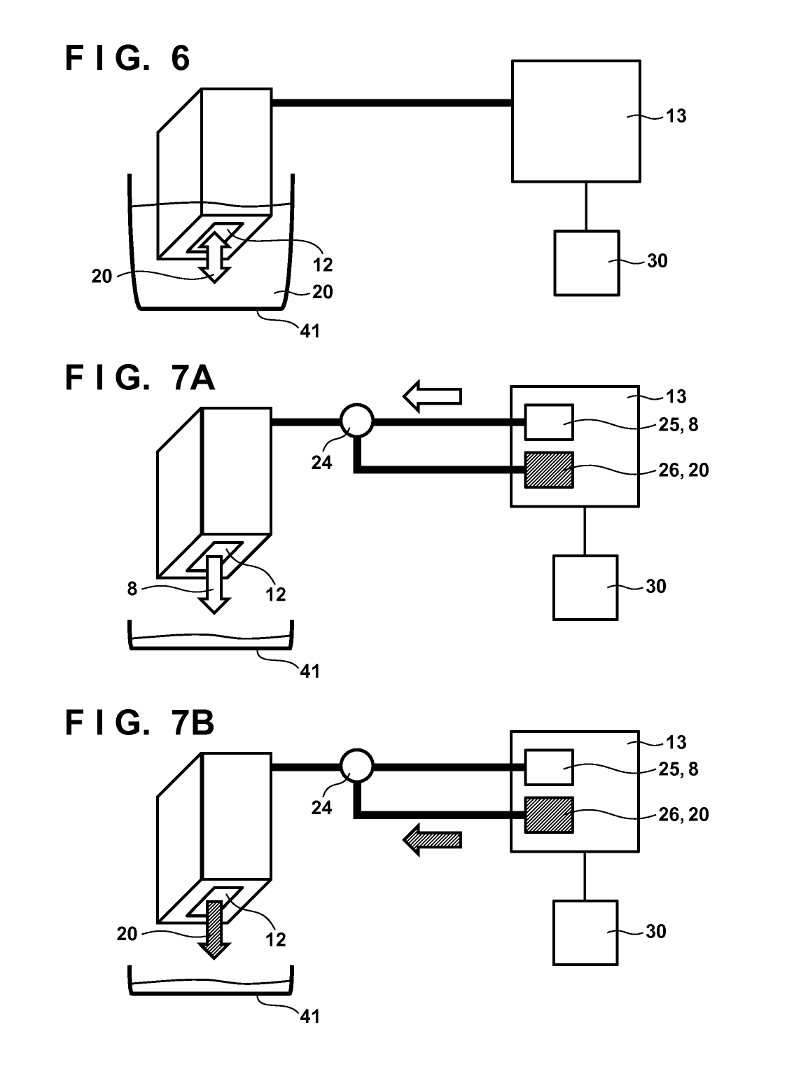

As shown in FIG. 6, while the discharge surface 12 is soaked in the cleaning solution 20 put into the drain tray 41, the pressure control unit 13 may be used to repeatedly suck and discharge the cleaning solution 20. While the discharge surface 12 is soaked, the inkjet discharge actuators may be driven, or the cleaning solution 20 may be sucked and discharged by operating the pump of the pressure control unit 13 to change the pressure.

As shown in FIGS. 7A-7B, two systems, that is, a resist supply system 25 and a cleaning solution supply system 26 may be arranged in the pressure control unit 13, and a switching valve 24 may be used to switch between supply of the resist and supply of the cleaning solution. In the normal state, the switching valve 24 is set to supply the resist 8 (FIG. 7A). At the time of maintenance, the switching valve 24 is switched to the cleaning solution supply system 26 (FIG. 7B). At the time of cleaning, the cleaning solution 20 is discharged to the drain tray 41 to recover clogging of the discharge nozzles and the like. After cleaning, the switching valve 24 is switched to the resist supply system 25 to supply the resist 8. Since the cleaning solution is mixed into the resist for a while after switching, it is preferable to return to the normal operation after discharging a given amount of the resist to the drain tray 41, and replacing the cleaning solution.

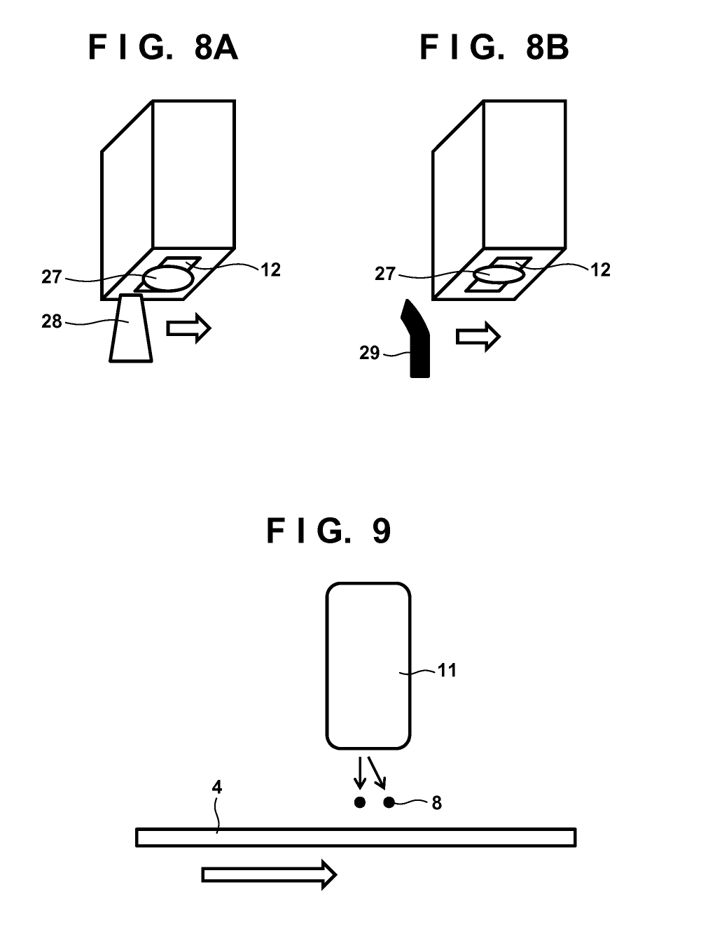

After cleaning using the cleaning solution, a droplet 27 may remain near the discharge surface 12. To process the droplet 27, as shown in FIG. 8A, a suction nozzle 28 is used to scan the discharge surface and collect the droplet 27. Alternatively, as shown in FIG. 8B, a blade 29 made of a flexible material such as rubber may be brought into contact with the discharge surface to scan it, and the droplet 27 may be moved and removed.

The cleaning solution 20 is preferably the resist itself, isopropyl alcohol (IPA), or acetone. As for the components of the resist, a liquid containing only a monomer liquid without any light-curing initiator may be used.

As an index of the solubility of the solution, an SP value (dissolution parameter or solubility parameter) is known. It is empirically known that the solubility becomes larger as the difference between the SP values of two solutions is smaller. The resist used in a nanoimprint step contains an acrylic monomer liquid as a main component, and has an SP value of about 9.5. Since isopropyl alcohol has an SP value of about 11 and acetone has an SP value of about 10, both the SP values are close to that of the resist, and thus both the solutions dissolve the resist well. As described above, a solvent having an SP value such that the difference between the SP value and the SP value of the resist falls within the range of ±2 is suitable as a cleaning solution.

When the resist is dried and adhered or when the resist is exposed to leakage light or the like, cured, and adhered, no resist may be discharged or the landing position may shift. A preferred cleaning solution may be different for each case. Therefore, a plurality of types of cleaning solutions may be used. That is, cleaning may be performed using isopropyl alcohol, and then performed using acetone. It is possible to perform cleaning by combining a plurality of steps, for example, by soaking and wetting the discharge surface with the resist, cleaning the discharge surface using nonwoven fabric with isopropyl alcohol, and cleaning the discharge surface with ultrasonic waves by switching to acetone. A plurality of types of cleaning solutions may be mixed in proportions so that an SP value is closer to that of the resist.

It has been found that the cleaning effect improves by repeating a cleaning sequence. It has been confirmed from our study that in a cleaning method of wiping the discharge surface with nonwoven fabric wet with the cleaning solution, repeating cleaning five times sufficiently cleans the discharge surface.

The cleaning processing by the cleaning solution is effective as a function of recovering the discharge performance even when the discharge surface is polluted with a component other than the solid resist, for example, the discharge surface is polluted with dust in the imprint apparatus or the discharge surface is polluted due to mistakes at the time of maintenance.

Cleaning using the cleaning solution is preferably processed automatically within the imprint apparatus 100. To do this, the imprint apparatus 100 includes a unit called a recovery system unit 40. The recovery system unit 40 constitutes the drain tray 41 for receiving the cleaning solution 20 or the resist 8, and has a cleaning solution supply mechanism 43. The cleaning solution supply mechanism 43 includes a mechanism of supplying the cleaning solution, a tank for storing the cleaning solution, and a mechanism of collecting waste liquid after cleaning. The drain tray 41 and the cleaning solution supply mechanism 43 are connected by a pipe such as a tube 42.

The recovery system unit 40 is preferably arranged outside the driving range of the substrate stage 6 in the imprint apparatus 100. Alternatively, at the time of a normal imprint operation, the recovery system unit 40 is retracted outside the driving range of the substrate stage 6. At the time of maintenance, the substrate stage 6 is retracted to a location other than the maintenance position of the discharge nozzles, and then the recovery system unit 40 may be inserted to the driving range of the substrate stage in the normal state. In this case, a moving mechanism of moving the recovery system unit 40 is preferably provided.

To discharge, from the imprint apparatus, the volatile components or a mist of the cleaning solution used for maintenance, an exhaust system 44 is arranged in the recovery system unit 40. In the exhaust system 44, a fan (not shown) or the like exhausts the atmosphere around the maintenance position outside a clean room in which the imprint apparatus is installed. The exhaust system 44 is preferably arranged to surround especially the drain tray 41 of the recovery system unit 40. In the imprint apparatus, air flows through a space where the mold 1 and the substrate 4 exist so as to form a given air current to prevent pollution with particles. Since the volatile components or a mist of the cleaning solution flow by the air current, the exhaust system 44 is preferably arranged downstream of the air current around the tray. The exhaust system 44 is formed from an exhaust hood, an exhaust fan, an exhaust duct, and the like. A filter for removing the exhausted volatile components and the like or a mechanism of making them harmless may be added.

103. The actuators of the discharge nozzles are vibrated at high speed (the ultrasonic wave band).

In the above cleaning step, the discharge surface 12 and its vicinity are cleaned. If an abnormality still remains, clogging or adhesion may have occurred in a flow path within a discharge nozzle. To apply a physical force to the flowing path of the nozzle, the discharge actuator (a piezo actuator or the like) of the inkjet mechanism is vibrated to change the pressure of the resist within the nozzle or generate a current, thereby preventing clogging. The drive frequency of the actuator may be increased to the ultrasonic wave band exceeding 100 kHz to swing the resist at a high frequency and to generate cavitation, thereby preventing clogging. After this operation, an operation of draining the resist to the drain tray 41 is performed, and the clogged solids are discharged or air bubbles are removed.

104. A discharge timing offset is adjusted and corrected.

Even if the above maintenance operation is performed, if the discharge characteristics are not recovered, a step of changing the discharge timing is performed for a nozzle whose discharge characteristics are not recovered. As shown in FIG. 9, the landing position shifts when a discharge direction changes in a direction in which the substrate stage moves the substrate 4. Therefore, the resist is controlled to land at a normal landing position by measuring the shift amount of the landing position of the resist discharged to the substrate, and offsetting the discharge timing of the nozzle according to the movement of the substrate stage.

105. Other nozzles are used as complements without using a discharge failure nozzle.

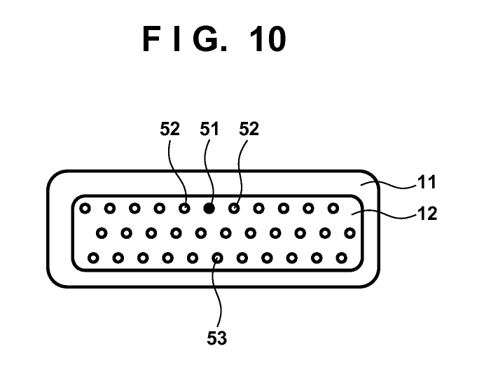

Even if the above maintenance operation is performed, if there is a nozzle whose discharge characteristics are not recovered, a nozzle 51 whose discharge characteristics are not recovered is prohibited from discharging the resist and the discharge amounts and discharge frequencies of adjacent nozzles 52 are increased, as shown in FIG. 10, thereby changing a discharge pattern so as to complement discharge of the resist which should be discharged by the nozzle that discharges no resist. If there are a plurality of arrays of the inkjet discharge nozzles, a nozzle 53 in an array different from that in which the nozzle that discharge no resist exists may be substituted for the nozzle that discharges no resist.

By performing the above-described steps, it is possible to satisfactorily maintain the discharge nozzles, and prevent an imprint defect caused by a resist discharge failure.

[Method of Manufacturing Article]

A method of manufacturing a device (for example, a semiconductor integrated circuit device, liquid crystal display device, or MEMS) as an article includes a step of transferring (forming) a pattern onto a substrate (for example, a wafer, glass plate, or film-like substrate) using the above-described imprint apparatus. The manufacturing method can also include a step of etching the substrate onto which the pattern is transferred. Note that when manufacturing another article such as a patterned medium (recording medium) or an optical element, the manufacturing method can include, instead of the etching step, another processing step of processing the substrate onto which the pattern is transferred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A head cleaning method performed by a liquid discharge apparatus including a head configured to discharge a resist containing an acrylic monomer as a main component, the method comprising:
using a cleaning solution to clean a liquid discharge surface of the head and a vicinity of the liquid discharge surface,
wherein a difference between a dissolution parameter (SP value) of the cleaning solution and a dissolution parameter of the resist falls within a range of ±2.

2. The head cleaning method according to claim 1, wherein the cleaning solution is one of isopropyl alcohol and acetone.

3. The head cleaning method according to claim 1, wherein the cleaning solution is a cleaning solution obtained by mixing a plurality of liquids so as to make the dissolution parameter close to that of the resist.

4. A method in a liquid discharge apparatus wherein when a resist discharge characteristic of the head is abnormal, the liquid discharge apparatus sequentially performs the steps of:
draining a resist in a vicinity of an opening of a discharge unit by discharging the resist,
cleaning the vicinity of the opening of the discharge unit using the cleaning solution,
swinging the resist in the vicinity of the opening of the discharge unit by operating an actuator of the head,
changing a discharge timing of the resist discharged from the head based on information about a position at which the resist discharged from an abnormal discharge nozzle of the head lands, and
changing to stop discharge from the abnormal discharge nozzle of the head and to discharge the resist so as to complement, by using another nozzle, the nozzle which has been stopped to discharge the resist.

5. The method according to claim 4, wherein the liquid discharge apparatus includes a supply mechanism configured to supply the cleaning solution in the step of cleaning the discharge head, and a tray configured to receive the cleaning solution are arranged.

6. The method according to claim 4, wherein the liquid discharge apparatus includes a mechanism configured to exhaust air around the discharge head in the step of cleaning the discharge head.

7. An imprint apparatus having a liquid discharge apparatus which performs a head cleaning method performed by a liquid discharge apparatus including a head configured to discharge a resist containing an acrylic monomer as a main component, the method comprising:
using a cleaning solution to clean a liquid discharge surface of the head and a vicinity of the liquid discharge surface,
wherein a difference between a dissolution parameter (SP value) of the cleaning solution and a dissolution parameter of the resist falls within a range of ±2.

8. A method of manufacturing an article, the method comprising:
forming a pattern on a substrate using an imprint apparatus having a liquid discharge apparatus which performs a head cleaning method performed by a liquid discharge apparatus including a head configured to discharge a resist containing an acrylic monomer as a main component, the method comprising:
using a cleaning solution to clean a liquid discharge surface of the head and a vicinity of the liquid discharge surface,
wherein a difference between a dissolution parameter (SP value) of the cleaning solution and a dissolution parameter of the resist falls within a range of ±2; and
processing the substrate on which the pattern has been formed to manufacture the article.
